(19) United States
(12) Patent Application Publication
(10) Pub. No.: US 2009/0201515 A1
(43) Pub. Date: Aug. 13, 2009

(54) IMAGE PROCESSING APPARATUS, IMAGE PROCESSING METHOD, AND STORAGE MEDIUM

(75) Inventor: Yohei Kiuchi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/371,393

(22) Filed: Feb. 13, 2009

(30) Foreign Application Priority Data
Feb. 13, 2008 (JP) 2008-032269

(51) Int. Cl. G06K 15/02

(52) U.S. Cl. 358/1.2

(57) ABSTRACT

An image processing apparatus includes a storing unit configured to store, as a document, resolution-independent data, print setting data, and resolution-dependent drawing data obtained by converting the resolution-independent data according to the print setting data, while associating the resolution-independent data, the print setting data, and the resolution-dependent drawing data with one another, and a control unit configured to perform a printing process using one of the resolution-independent data and the resolution-dependent drawing data according to a print setting set during printing and the print setting data.

### BACKGROUND OF THE INVENTION

1. Field of the Invention

The present invention relates to an image processing apparatus, an image processing method, and a storage medium.

2. Description of the Related Art

Japanese Patent Application Laid-Open No. 2005-269629 discusses a technique for realizing a reprinting function that facilitates preventing image degradation caused by an editing operation and that also facilitates performing printing at high speed. The technique divides input page description language (PDL) data into PDL data for each page, which is then stored in an auxiliary storage device along with print setting status information. The PDL data for each page is then rendered, and if the rendering process is performed for longer than a predetermined period, raster data is stored in the auxiliary storage device. On the other hand, if the rendering process is not performed for longer than the predetermined period, the raster data is not stored in the auxiliary storage device.

Further, Japanese Patent Application Laid-Open No. 2006-23942 discusses a technique that facilitates preventing image degradation caused by a resolution conversion process. More specifically, the technique converts raster data input by an image input device into drawing data that does not depend on the resolution of the image input device. Such a process for converting raster data into resolution-independent data is referred to as vectorization or vectorizing. Further, the data acquired as a result of vectorization is referred to as vector data.

If the above-described technique is used, vector data is re-converted (rasterized) into raster data to output an image, so that a resolution conversion of the raster data is not performed. Therefore, image degradation caused by a resolution conversion process can be prevented.

Further, Japanese Patent Application Laid-Open No. 2005-173725 discusses a print server, a print history management method, and a print history management program, which are capable of simplifying a reprinting operation.

However, a problem arises when using the technique discussed in Japanese Patent Application Laid-Open No. 2005-269629, which can only store a single print setting. Consequently, if a user sets a new print setting, a reprinting procedure that corresponds to the new print setting cannot be stored. Otherwise, it becomes necessary to rewrite the reprinting procedure that corresponds to the new print setting on a memory area in which the single print setting is stored. Therefore, every time a printing process is performed using a new print setting, a rendering process according to the new print setting is performed, so that printing becomes time-consuming.

Further, the technique discussed in Japanese Patent Application Laid-Open No. 2005-269629 stores print data as PDL data and raster data for each page. Therefore, if essentially resolution-dependent print data, e.g., scan data, is edited by performing scaling or rotation, image degradation may occur depending on the original document.

### SUMMARY OF THE INVENTION

According to an aspect of the present invention, an image processing apparatus includes a storing unit configured to store, as a document, resolution-independent data, print setting data, and resolution-dependent drawing data obtained by converting the resolution-independent data according to the print setting data, while associating the resolution-independent data, the print setting data, and the resolution-dependent drawing data with one another, and a control unit configured to perform a printing process using one of the resolution-independent data and the resolution-dependent drawing data according to a print setting set during printing and the print setting data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an image processing apparatus according to a first exemplary embodiment of the present invention.

FIG. 2 illustrates an example of a system according to the first exemplary embodiment of the present invention.

FIG. 3 is a block diagram illustrating an example of a control unit of each device according to the first exemplary embodiment of the present invention.

FIG. 4 is a block diagram illustrating an example of controller software according to the first exemplary embodiment of the present invention.

FIG. 5 illustrates a data structure of a document according to the first exemplary embodiment of the present invention.

FIG. 6 illustrates an example of a description of print setting information and display list (DL) management information according to the first exemplary embodiment of the present invention.

FIG. 7 illustrates an operation screen used in document printing according to the first exemplary embodiment of the present invention.

FIG. 8 is a flowchart illustrating a document printing process according to the first exemplary embodiment of the present invention.

FIG. 9 is a flowchart illustrating an initial printing process according to the first exemplary embodiment of the present invention.

FIG. 10 is a flowchart illustrating a reprinting process according to the first exemplary embodiment of the present invention.

FIG. 11 illustrates an operation screen for performing document printing according to a second exemplary embodiment of the present invention.

FIG. 12 illustrates an operation screen for performing a print setting restoration operation according to the second exemplary embodiment of the present invention.

FIG. 13 is a flowchart illustrating a document printing process according to the second exemplary embodiment of the present invention.

FIG. 14 illustrates an operation screen for performing an inter-device document replication process according to a third exemplary embodiment of the present invention.

FIG. 15 is a flowchart illustrating an inter-device document replication process according to the third exemplary embodiment of the present invention.

FIG. 16 is a flowchart illustrating a document printing process according to the third exemplary embodiment of the present invention.

FIG. 17 is a flowchart illustrating a DL re-registration printing process according to the third exemplary embodiment of the present invention.

### DETAILED DESCRIPTION OF THE EMBODIMENTS

Various exemplary embodiments, features, and aspects of the invention will be described in detail below with reference to the drawings.

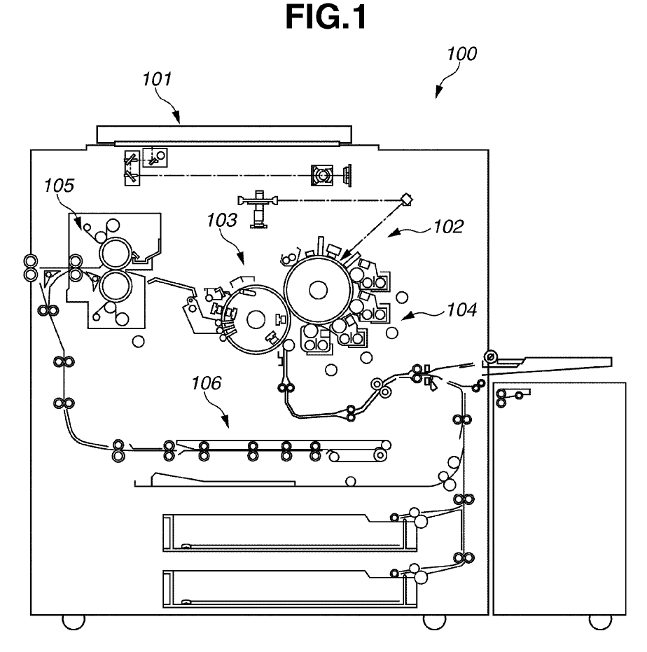

FIG. 1 illustrates a single-drum color multifunction peripheral (MFP), which is an example of an image processing apparatus according to a first exemplary embodiment of the present invention. The image processing apparatus can also be a four-drum tandem type color MFP, in which drums for respective colors, cyan (C), magenta (M), yellow (Y), and black (K), are disposed in parallel.

Referring to FIG. 1, a single-drum color MFP 100 includes a scanner unit 101, a laser exposure unit 102, a photosensitive drum 103, an image forming unit 104, a fixing unit 105, and a sheet feeding/conveyance unit 106. The single-drum color MFP 100 further includes a printer control unit (not illustrated) that controls the above-described units.

The scanner unit 101 illuminates an original document placed on an original document plate and optically reads the original image. The scanner unit 101 then converts the read original image into an electric signal to generate image data.

The laser exposure unit 102 causes a light beam, such as laser light, which is modulated according to the image data to be incident on a rotational polygonal mirror (polygon mirror) rotating at an equiangular speed. The laser exposure unit 102 thus irradiates the light beam on the photosensitive drum 103 as reflective scanning light.

The image forming unit 104 performs an electrophotographic process to form an image as described below. The image forming unit 104 rotatably-drives the photosensitive drum 103 and charges the photosensitive drum 103 using a charging device. The image forming unit 104 then develops a latent image formed on the photosensitive drum 103 by the laser exposure unit 102 using toner and transfers the toner image to a sheet. The image forming unit 104 further recovers a slight amount of toner that is not transferred and remains on the photosensitive drum 103. Developing units (developing stations) that respectively contain M, C, Y, and K toners sequentially perform the above-described electrophotographic process in turn while the sheet is wound on a predetermined position of a transfer drum and turned four times. After being turned four times, a full-color toner image of the four colors is transferred to the sheet. The sheet is then separated from the transfer drum and is conveyed to the fixing unit 105.

The fixing unit 105 includes a combination of rollers and belts, and a heat source such as a halogen heater. The fixing unit 105 heat-fuses the toner image transferred to the sheet by the image forming unit 104.

The sheet feeding/conveyance unit 106 includes more than one sheet repository, such as a sheet cassette or a paper deck. The sheet feeding/conveyance unit 106 separates one sheet from a plurality of sheets stored in the sheet repository according to an instruction from the printer control unit and conveys the sheet to the image forming unit 104. The sheet is then wound on the transfer drum of the image forming unit 104, turned four times and conveyed to the fixing unit 105. While the sheet turns four times on the transfer drum, the toner images of the above-described colors Y, M, C, and K are transferred to the sheet. Further, if images are to be formed on both sides of the sheet, control is performed so that a sheet that has passed through the fixing unit 105 passes through a conveyance path that conveys the sheet back to the image forming unit 104.

The printer control unit communicates with an MFP control unit that controls the entire MFP and performs control according to an instruction from the MFP control unit. Further, the printer control unit manages the statuses of the scanner unit 101, the laser exposure unit 102, the image forming unit 104, the fixing unit 105, and the sheet feeding/conveyance unit 106. The printer control unit gives instruction so that the above-described units smoothly operate in cooperation with one another.

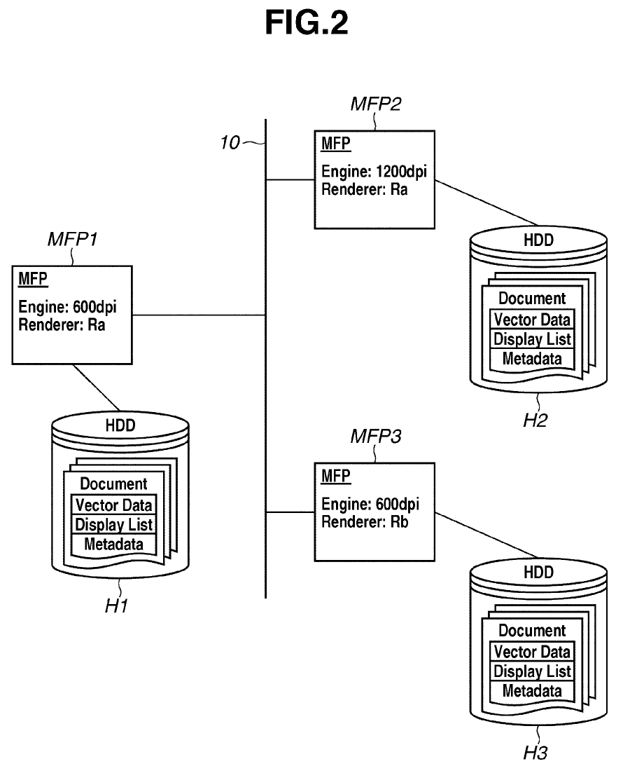

FIG. 2 is a block diagram illustrating an image processing system according to the present exemplary embodiment.

Referring to FIG. 2, the image processing system includes an MFP 1, an MFP 2, and an MFP 3 that are interconnected via a local area network (LAN) 10. The MFP 1, the MFP 2, and the MFP 3 are provided with hard disk drives (HDDs, i.e., secondary storage devices) H1, H2, and H3, respectively. The MFP 1, MFP 2, and MFP 3 can communicate with one another using a network protocol. The above-described MFPs connected to the LAN 10 are not limited to be physically positioned in the above-described manner. Further, devices other than the MFPs (such as personal computers (PCs), various servers, and printers) can be connected to the LAN 10.

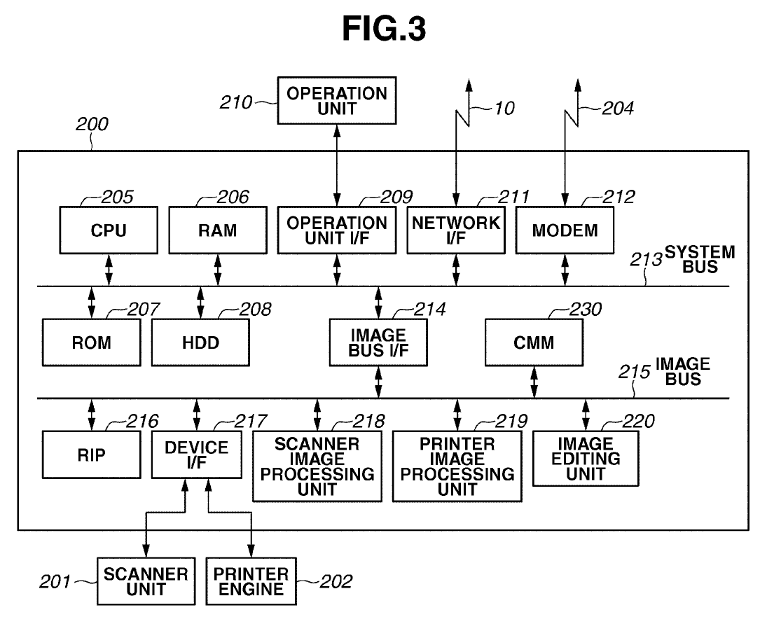

FIG. 3 is a block diagram illustrating an example of a control unit (controller) in an MFP according to the present exemplary embodiment.

Referring to FIG. 3, a control unit 200 connects to a scanner unit 201, i.e., an image input device, and a printer engine 202, (i.e., an image output device), and controls reading and printing of image data. Further, the control unit 200 connects to the LAN 10 and a public line 204 and performs control of inputting and outputting image information and device information via the LAN 10.

The scanner unit 201 corresponds to the scanner unit 101 illustrated in FIG. 1. Further, the printer engine 202 corresponds to the laser exposure unit 102, the photosensitive drum 103, the image forming unit 104, the fixing unit 105, and the sheet feeding/conveyance unit 106 illustrated in FIG. 1.

A central processing unit (CPU) 205 controls the entire MFP.

A random access memory (RAM) 206 is a system work memory on which the CPU 205 operates, and is an image memory that temporarily stores an input image data.

A read-only memory (ROM) 207 is a boot ROM that stores a boot program of the system.

The HDD 208, (i.e., the above-described hard disk drive), stores system software for performing various processes and input image data.

An operation unit interface (I/F) 209 is an interface unit of an operation unit 210 including a display screen that can display image data. The operation unit I/F 209 thus outputs data of an operation screen on the operation unit 210. Further, the operation unit I/F 209 notifies the CPU 205 of information input by an operator from the operation unit 210.

A network I/F 211 is realized by a LAN card. The network I/F 211 is connected to the LAN 10 to exchange information between an external device.

A modem 212 connects to the public line 204 and exchanges information with an external device.

The above-described units included in the control unit 200 are connected via a system bus 213.

An image bus I/F 214 is an interface that connects the system bus 213 and an image bus 215 that transfers image data at high speed. The image bus I/F 214 is thus a bus bridge that converts a data structure.

A raster image processor (RIP) 216, a device I/F 217, a scanner image processing unit 218, a printer image processing unit 219, an image editing unit 220, and a color management module (CMM) 230 are connected to the image bus 215.

The RIP 216 rasterizes PDL code or vector data into an image.

The device I/F unit 217 connects the scanner unit 201 and the printer engine 202 to the controller unit 200 and performs synchronous/asynchronous conversion of the image data.

The scanner image processing unit 218 corrects, processes, and edits image data input from the scanner unit 201.

The printer image processing unit 219 corrects and performs a resolution conversion process appropriate for the printer engine 202 on the image data to be printed out.

The image editing unit 220 performs various image processing, such as rotation, compression, and decompression of the image data.

The CMM 230 is a dedicated hardware module that performs a color conversion process (also referred to as a color space conversion process) on image data, based on a profile or calibration data.

More specifically, a profile is information, (e.g., a function or a look up table (LUT)), for converting color image data expressed in a device-dependent color space into color image data expressed in a device-independent color space (such as L*a*b).

Further, calibration data is data for correcting a color reproduction characteristic of the scanner unit 201 or the printer engine 202 in the color MFP 100.

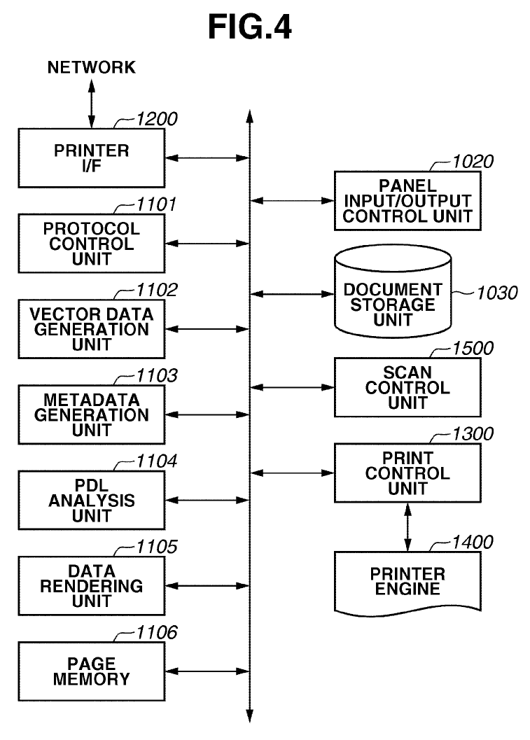

FIG. 4 is a block diagram illustrating controller software that controls an operation of the MFP.

Referring to FIG. 4, a printer I/F 1200 is an interface for exchanging data with an external device.

A protocol control unit 1101 communicates with an external device by analyzing and transmitting a network protocol.

A vector data generation unit 1102 vectorizes raster (image) data into vector data, which is a drawing description that does not depend on resolution.

A metadata generation unit 1103 generates secondary information acquired in the vectorization process as metadata. Metadata is auxiliary data, including print setting information and Display List management information, used in a print setting or a search.

A PDL analysis unit 1104 analyzes and converts PDL data and vector data into intermediate code (i.e., Display List (hereinafter, referred to as DL)), which is of a form that can be more easily processed. The intermediate code generated by the PDL analysis unit 1104 is transmitted to a data rendering unit 1105 and is then processed.

The data rendering unit 1105 rasterizes the intermediate code into raster data, which is then sequentially drawn in a page memory 1106.

The page memory 1106 is a volatile memory, which temporarily stores the raster data rasterized by the data rendering unit 1105, (i.e., a renderer).

A panel input/output control unit 1020 controls an input to and an output from the operation unit 210.

A document storage unit 1030 stores a data file that includes vector data, DL, and metadata in a unit of one set of input document (i.e., a job). The document storage unit 1030 is realized by a secondary storage device, such as an HD. Hereinafter, such a data file is referred to as a “document” in the present exemplary embodiment.

A scan control unit 1500 corrects, processes, and edits image data input from the scanner unit 101.

A print control unit 1300 converts a content of the page memory 1106 into a video signal and transfers the video signal to a printer engine 1400. The printer engine 1400 corresponds to the above-described printer engine 202 illustrated in FIG. 2 and is a printing mechanism which forms the received video signal into an image to be permanently visible on a recording sheet.

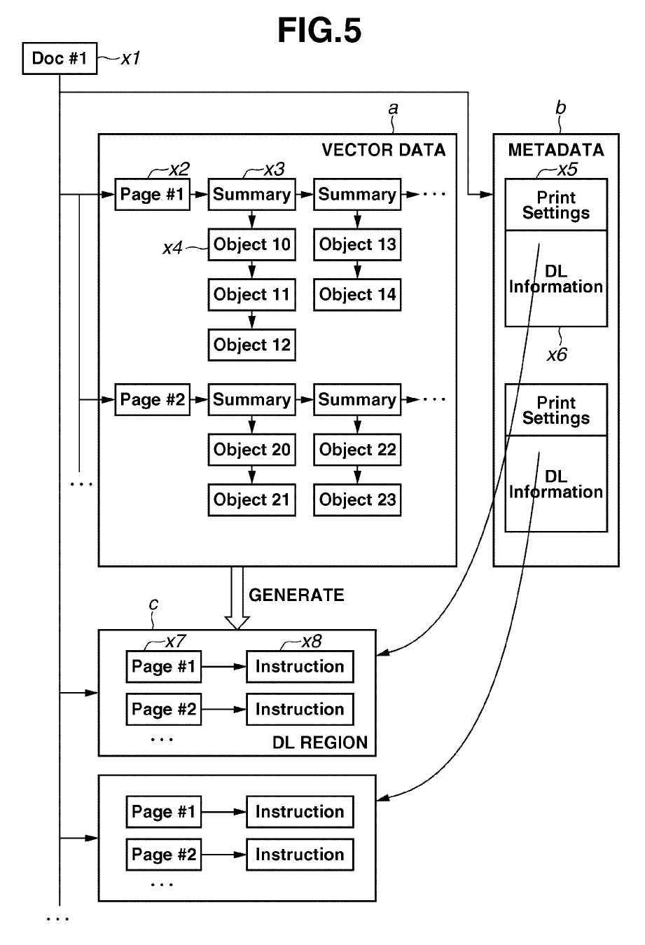

FIG. 5 illustrates a data structure of a document.

Referring to FIG. 5, the document is data including a plurality of pages. The document can be broadly-divided into vector data a, metadata b, and a DL region c, and is of a hierarchical structure with a document header x1 at the top.

The vector data a further includes a page header x2, summary information (Summary) x3, and an object (Object) x4.

The metadata b further includes print setting information (Print Settings) x5 and DL management information (DL Information) x6.

The DL information c further includes a page header x7 and an instruction for performing rendering and rasterizing (Instruction) x8.

Storage locations of the vector data, the DL region, and the metadata are described in the document header x1. More specifically, the document header x1 associates the vector data, the DL, and the metadata with one another.

The vector data a is resolution-independent drawing data. Consequently, layout information such as a size and a direction of the page is described in the page header x2. Rendering data, such as a line, a polygon, or a Bezier curve, is linked to the object x4, and a plurality of objects are collectively associated with the summary information x3. The summary information x3 thus collectively expresses a feature of a plurality of objects.

The metadata b is auxiliary information to be used in performing control and not related to a drawing process. A print setting that has been previously applied to the document is described in the print setting information x5. Further, information about the DL region c that corresponds to the print setting information x5 is described in the DL management information x6.

The DL region c stores intermediate code (i.e., a DL) to be rendered by a renderer. The page header x7 includes a description of a drawing information (instruction) management table of the page. The instruction x8 includes resolution-dependent drawing information (resolution-dependent drawing data), which is a DL.

More specifically, the DL is generated in the DL region c by converting resolution-independent drawing data according to the print setting. The DL is stored for each print setting. Further, whether the DL is stored for each page can be controlled as will be described below. Further, the generated DL is selectively stored in the document according to a raster generation time.

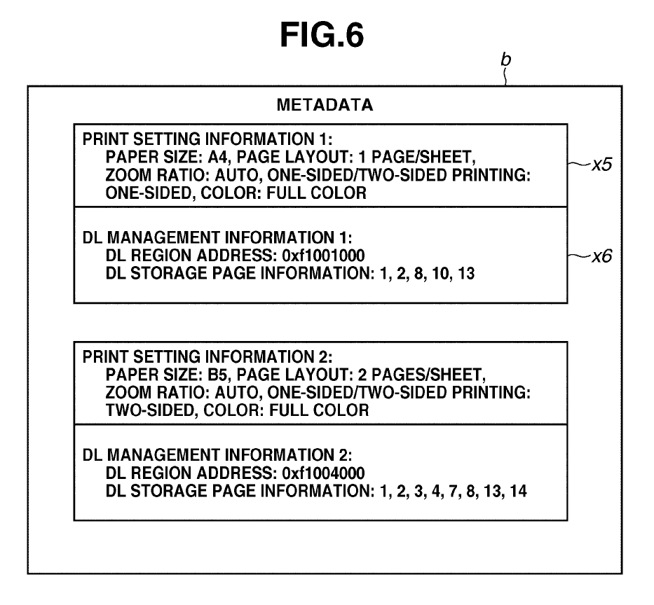

FIG. 6 illustrates an example of the print setting information x5 and the DL management information x6 described in the metadata b.

Referring to FIG. 6, a print setting which was previously applied to the document is described in the print setting information x5. Since the DL management information x6 in the metadata b makes reference to the DL region c, the DL region c that corresponds to the print setting information x5 can be searched from the DL management information x6. Further, a list of pages included in the DL region c that corresponds to the print setting information x5 is described as a DL storage page list in the DL management information x6 of the metadata b.

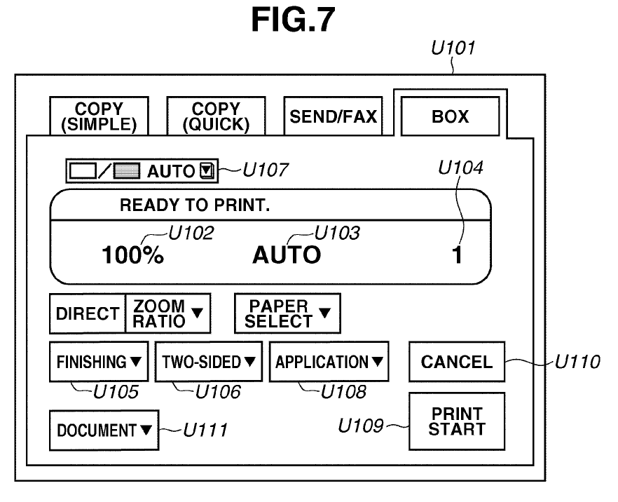

FIG. 7 illustrates an example of a screen displayed on the operation unit 210 in a case where a user instructs printing of a document stored in a BOX (i.e., an HD of the color MFP 100) according to the present exemplary embodiment.

Referring to FIG. 7, a screen U101 is displayed on the operation unit 210 for the user to designate a print setting and to instruct print start of a document. The user can set zoom ratio U102, paper size U103, number of prints U104, finishing U105, one-sided/two-sided printing U106, color U107, and application mode U108 by operating the operation unit 210. If the user presses a print start button U109, the MFP 100 starts a document printing process. Further, the user can cancel the process by pressing a cancel button U110.

Further, when the user presses a document button U111, the MFP 100 displays a list of documents stored in the HD. The user can then select the desired document from the displayed list of documents.

If the user is to make a copy of an original document instead of printing a document stored in the BOX, the user switches to a “copy (simple)” tab or “copy (quick)” tab and gives instructions. Further, at the same time as making such a copy, the MFP 100 can read and vectorize the original document and generate a DL to be stored in the HD as a document as necessary, as will be described below.

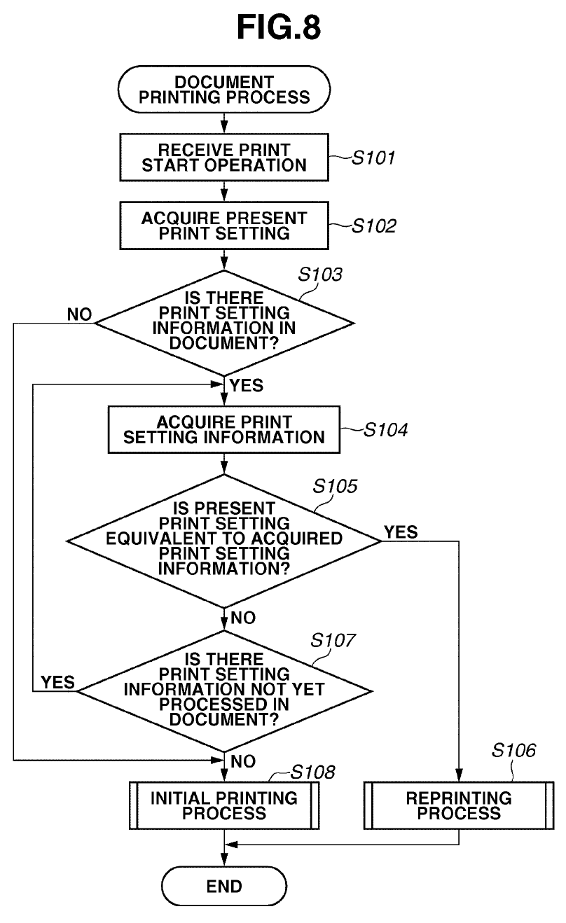

A process performed by the above-described image processing apparatus according to the first exemplary embodiment will be described below with reference to FIG. 8.

In step S101, the CPU 205 receives a print start operation by the user pressing the print start button U109 on the operation unit 210.

In step S102, the CPU 205 acquires the present print setting (a print setting of the current printing) input by the user from the operation unit 210.

In step S103, the CPU 205 determines whether there is print setting information x5 in the metadata of the document instructed by the user to be printed from the list of documents. If the CPU 205 determines that there is print setting information x5 in the metadata b of the document (YES in step S103), the process proceeds to step S104.

In step S104, the CPU 205 acquires one print setting information.

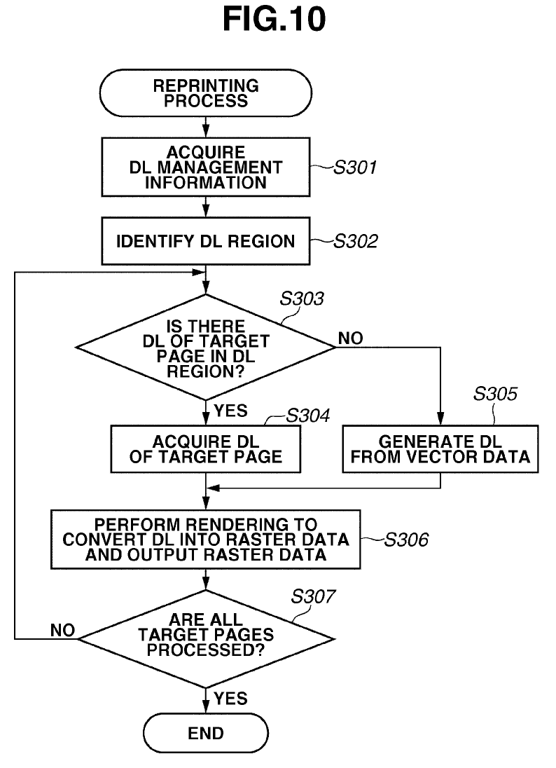

In step S105, the CPU 205 determines whether the present print setting is equivalent to the acquired print setting information. If the CPU 205 determines that the present setting is equivalent to the acquired print setting information (YES in step S105), the process proceeds to step S106. In step S106, the CPU 205 executes a reprinting process to be described below with reference to FIG. 10.

On the other hand, if the CPU 205 determines that the present print setting is not equivalent to the acquired print setting information (NO in step S105), the process proceeds to step S107.

In step S107, the CPU 205 determines whether there is print setting information x5 that has not been processed in the metadata b of the document. If the CPU 205 determines that there is print setting information x5 that has not been processed (where processed means determined whether the print setting information is equivalent to the present print setting) in the metadata b of the document (YES in step S107), the process returns to step S104.

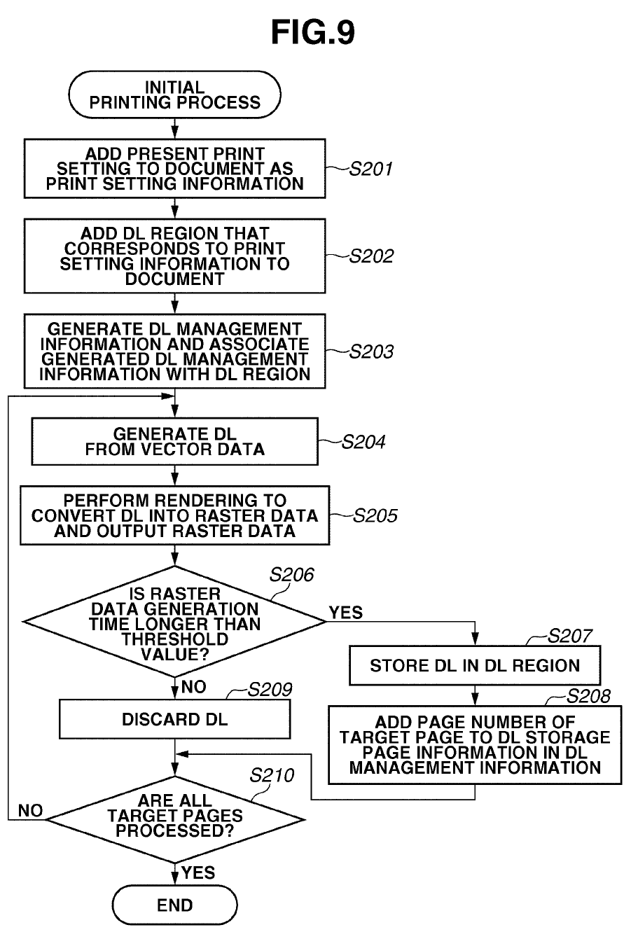

If, in step S103, the CPU 205 determines that print setting information x5 does not exist in the metadata b of the document (NO in step S103), the process proceeds to step S108. In step S108, the CPU 205 executes an initial printing process to be described below with reference to FIG. 9.

If, in step S107, the CPU 205 determines that there is no print setting information x5 that has not been processed (where processed means determined whether the print setting information is equivalent to the present print setting) (NO in step S107), the CPU 205 determines that the printing has not been performed using the present print setting. The process thus proceeds to step S108, in which the CPU 205 executes the initial printing process.

In the above-described process, if the present print setting is equivalent to the acquired print setting information, the DL generated by applying a print setting set by the user to the present printing is (virtually) equivalent to the DL generated by applying the print setting information acquired in step S104 to the present printing.

For example, if the zoom ratio in the present print setting is different from the zoom ratio in the acquired print setting information, the DL generated according to each of the print settings are different. Consequently, the present print setting and the acquired print setting information are not equivalent. Print settings other than the zoom ratio that determine the equivalency of the print setting and the acquired print setting information are a type of layout of pages to be printed such as N-up, a paper type, one-sided printing, two-sided printing, and finishing information such as stapling direction.

On the other hand, if the present print setting and the acquired print setting information are the same except for the set number of prints, the present print setting and the acquired print setting information are equivalent.

The initial printing process executed in step S108 illustrated in FIG. 8 will be described below with reference to FIG. 9.

In step S201, the CPU 205 generates print setting information x5 from the present print setting (print setting of the current printing) instructed by the user from the operation unit 210 to the selected document. The CPU 205 then adds the generated print setting information x5 to the metadata b of the document.

In step S202, the CPU 205 adds to the document a DL region c that corresponds to the added print setting information x5.

In step S203, the CPU 205 generates DL management information x6 that corresponds to the added print setting information x5 and associates the DL management information x6 with the DL region added in step S202. By such operations, the print setting information x5, the DL management information x6, and the DL region c that correspond to the present print setting (print setting of the current printing) are generated in the document.

The CPU 205 then sequentially performs a printing process on the print target pages.

In step S204, the CPU 205 causes the PDL analysis unit 1104 to convert the vector data a of the target page to a DL to generate the DL.

In step S205, the CPU 205 causes the data rendering unit 1105 to convert the DL into raster data for drawing and to output the raster data to the device I/F 217.

In step S206, the CPU 205 determines at the device I/F 217 whether the time taken in generating the raster data in the processes of steps S204 to S205 is longer than a predetermined threshold value. Generally, a raster data generation takes time in a case where a page includes many objects (image, text, and graphics), many objects overlap, and a value of N in N-up printing is large.

If the CPU 205 determines that the raster data generation time is longer than the threshold value (YES in step S206), the process proceeds to step S207. In step S207, the CPU 205 stores the DL generated in step S204 in the DL region c of the document. More specifically, only the DL of a page whose raster data generation time is long can be stored. Consequently, in a case where the present print setting is equivalent to the acquired print setting information, the stored DL can be used and rastered, so that it is not necessary to covert the vector data to a DL. As a result, the raster data can be generated at high speed.

In step S208, the CPU 205 adds a page number of the process target page to the DL storage page information of the DL management information x6. The process then proceeds to step S210.

On the other hand, if the CPU 205 determines that the raster data generation time is not longer than the threshold value (NO in step S206), the process proceeds to step S209. In step S209, the CPU 205 discards the DL generated in step S204. As a result, since the DL of a page whose raster data generation time is not longer than the threshold value is not stored, the DL stored in the document can be limited. Therefore, the data amount can be decreased.

In step S210, the CPU 205 determines whether all of the pages to be processed have been processed. If the CPU 205 determines that all of the pages to be processed have not yet been processed (NO in step S210), the process returns to step S204. On the other hand, if the CPU 205 determines that all of the pages to be processed have been processed (YES in step S210), the process ends.

By performing the above-described process, the DL of the page whose raster data generation time is longer than a predetermined threshold value is stored in the document at the same time as the document is printed. Further, the page number is described in the DL management apparatus x6.

The reprinting process described in step S106 illustrated in FIG. 8 will be described below with reference to FIG. 10.

In step S301, the CPU 205 acquires the DL management information x6 that corresponds to the print setting information x5 equivalent to the print setting set for reprinting. The CPU 205 acquires the DL management information x6 from the metadata b of the document selected by the user using the operation unit 210.

In step S302, the CPU 205 identifies the DL region c associated with the DL management information x6 acquired in step S301. The CPU 205 then sequentially performs a printing process of each page to be printed.

In step S303, the CPU 205 determines whether there is a DL of the print target page in the DL region c of the document. More specifically, the CPU 205 determines whether there is a page number of the print target page in the DL storage page information of the DL management information x6.

If the CPU 205 determines that the DL of the print target page is included in the DL region c (YES in step S303), the process proceeds to step S304. In step S304, the CPU 205 acquires the DL of the print target page from the DL region c. The process then proceeds to step S306.

On the other hand, if the CPU 205 determines that the DL of the print target page is not included in the DL region c (NO in step S303), the process proceeds to step S305. In step S305, the CPU 205 causes the PDL analysis unit 1104 to convert the vector data a of the print target page into a DL to generate the DL.

In step S306, the CPU 205 converts the DL into raster data for drawing an image using the data rendering unit 1105. The CPU 205 then outputs the raster data to the device I/F 217.

In step S307, the CPU 205 determines whether all the print target pages have been printed. If the CPU 205 determines that there is a page that is not yet printed (NO in step S307), the process returns to step S303. On the other hand, if the CPU 205 determines that all of the pages have been printed (YES in step S307), the process ends.

By performing the above-described process, printing is performed using a DL that corresponds to the print setting information x5 in a case where the DL exists in the document. On the other hand, printing is performed using the vector data a in a case where the DL does not exist in the document.

As described above, an image processing apparatus according to the first exemplary embodiment realizes a reprinting function in which there is no image degradation due to editing, by using vector data. Further, the image processing apparatus can store and manage print data that corresponds to a plurality of print settings. As a result, the image processing apparatus can perform high-speed printing even in a case where the image processing apparatus prints by switching between the plurality of print settings. Further, in a case where the DL which takes time to generate raster data is stored in a page, the image processing apparatus can render the page at high speed using the DL.

In the first exemplary embodiment, the user inputs an arbitrary print setting via the operation unit 210, and the CPU 205 of the MFP determines whether the input print setting is equivalent to the print setting information x5 stored in the metadata. The user thus needs to input all print settings via the operation unit 210 every time the user instructs printing, which might be burdensome for the user. Consequently, in a second exemplary embodiment of the present invention, a print setting restoration function can assist a user operation.

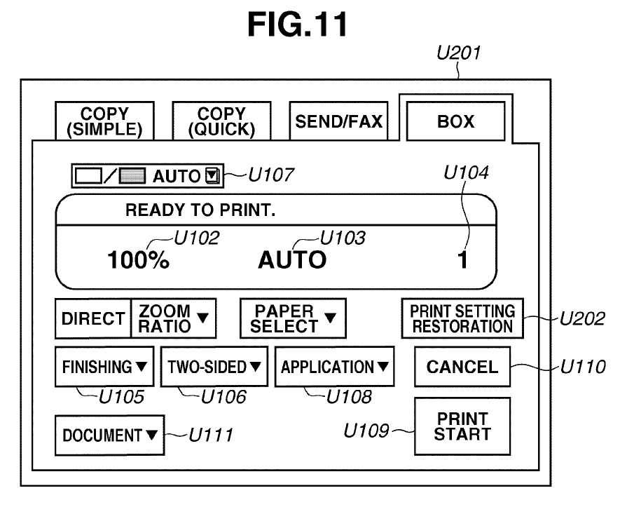

FIG. 11 illustrates an example of a screen displayed on the operation unit 210 when the user instructs a document printing process according to the second exemplary embodiment.

Referring to FIG. 11, a screen U201 is displayed on the operation unit 210, so that the user can make a print setting or instruct a document printing process to start. The user can set zoom ratio, paper size, number of prints, finishing, one-sided or double-sided printing, image quality, color, and an application mode by operating the operation unit 210.

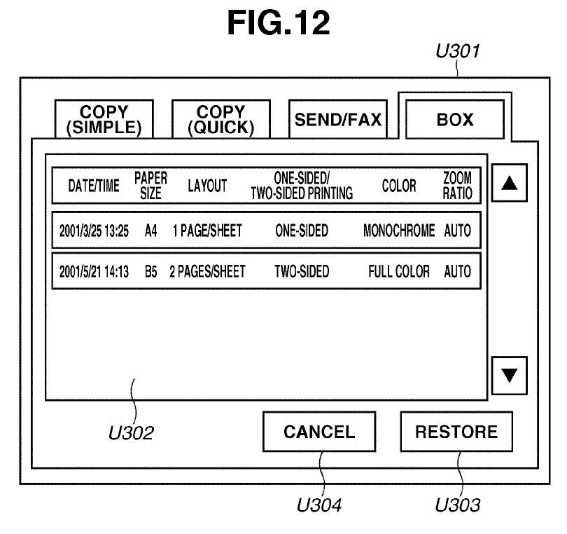

If the user presses the document button U111, a list of documents is displayed. The user then selects the desired document from the list of documents and presses a print setting restoration button U202. A print setting history screen U301 illustrated in FIG. 12 of the selected document is thus displayed. The user then presses the print start button U109 so that the document printing process is started.

FIG. 12 is an example of a screen displayed on the operation unit 210 in a case where the user instructs a print setting restoration process according to the second exemplary embodiment. The above-described print setting history screen U301 is displayed on the operation unit 210 so that the user can instruct the print setting restoration.

A list display area U302 displays all or a portion of print setting information x5 stored in the metadata b. If the user selects a print setting to be restored from the list display area U302 and presses a restoration button U303, the print setting is restored from the selected print setting information x5. The restored print setting is then reflected in the present print setting, and the screen returns to the screen U201 illustrated in FIG. 11.

Further, if the user presses a cancel button U304, the print setting restoration process is cancelled, and the screen returns to the screen U201 illustrated in FIG. 11. The user can then make a print setting and instruct the document printing process to be started.

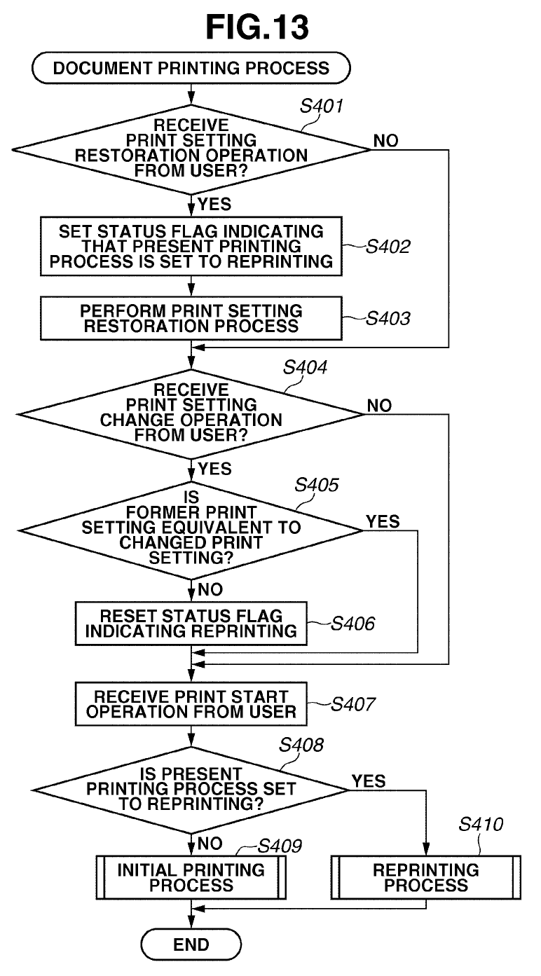

A document printing process according to the second exemplary embodiment will be described below with reference to a flowchart illustrated in FIG. 13.

In step S401, the CPU 205 determines whether a print setting restoration operation is received from the user operating the operation unit 210.

If the CPU 205 determines that the print setting restoration operation is received from the user (YES in step S401), the process proceeds to step S402. In step S402, the CPU 205 sets a status flag indicating reprinting.

In step S403, the CPU 205 performs a print setting restoration process by restoring the print setting information x5 and reflecting the restored print setting information in the present print setting.

On the other hand, if the CPU 205 determines that a print setting restoration operation is not received from the user (NO in step S401), the process proceeds to step S404. In step S404, the CPU 205 determines whether a print setting change operation is received from the user operating the operation unit 210.

If the CPU 205 determines that the print setting change operation is received from the user (YES in step S404), the process proceeds to step S405. In step S405, the CPU 205 determines whether the former print setting is equivalent to the changed print setting. To be more specific, if the former print setting is equivalent to the changed print setting, the present print setting is equivalent to the acquired print setting information as described in the first exemplary embodiment.

On the other hand, if the CPU 205 determines that the print setting change operation is not received from the user (NO in step S404), the process proceeds to step S407 described below.

In step S405, if the CPU 205 determines that the former print setting is not equivalent to the changed print setting (NO in step S405), the process proceeds to step S406. In step S406, the CPU 205 resets the status flag indicating reprinting. On the other hand, if the CPU 205 determines that the former print setting is equivalent to the changed print setting (YES in step S405), the process proceeds to step S407.

In step S407, the CPU 205 receives a print start operation from the user pressing the print start button U109 without changing the print setting, or after changing the print setting.

In step S408, the CPU 205 determines whether the present printing process is set to reprinting by referring to the status flag indicating reprinting.

If the CPU 205 determines that the present printing process is not set to reprinting (NO in step S408), the process proceeds to step S409. In step S409, the CPU 205 performs an initial printing process described with reference to FIG. 9 in the first exemplary embodiment.

On the other hand, if the CPU 205 determines that the present printing process is set to reprinting (YES in step S408), the process proceeds to step S410. In step S410, the CPU 205 performs the reprinting process described with reference to FIG. 10 in the first exemplary embodiment.

As described above, an image processing apparatus according to the second exemplary embodiment realizes a reprinting function in which there is no image degradation due to editing, by using vector data. Further, the image processing apparatus can store and manage print data that corresponds to a plurality of print settings. As a result, the image processing apparatus can perform high-speed printing even in a case where the image processing apparatus prints by switching between the plurality of print settings.

Further, according to the second exemplary embodiment, the user can restore the print setting previously instructed and use the restored print setting. Therefore, operability can be improved when the user sets a print setting.

In the first and second exemplary embodiments, all DLs whose raster generation time is long are stored in the document for each print setting and for each page. Consequently, the data amount of the document tends to increase. For example, a data transfer amount becomes large when a document is replicated or transferred between devices. To solve such a problem, in a third exemplary embodiment of the present invention, the data transfer amount is reduced, and a print setting restoration function and a document printing process are realized in a device in which the document is replicated.

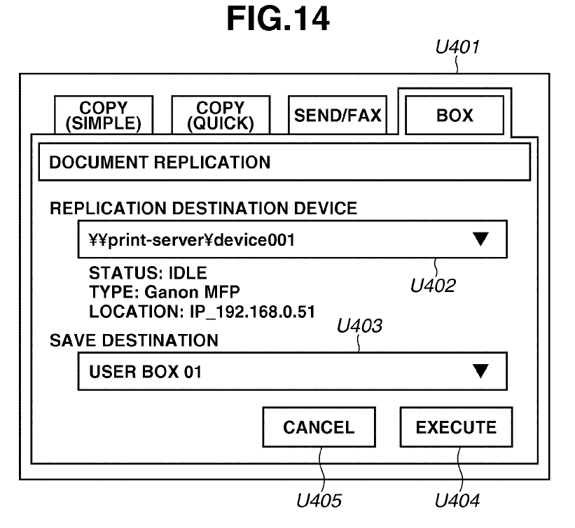

FIG. 14 illustrates an example of a screen displayed on the operation unit 210 when the user instructs the inter-device document replication process according to the third exemplary embodiment.

Referring to FIG. 14, a screen U401 is displayed on the operation unit 210 for the user to make a setting for the inter-device document replication process and to instruct the process to be started. The user operates the operation unit 210 to set a replication destination device U402 and a storage destination U403 of the document. The user then presses an execution button U404, and the inter-device document replication process is started. Further, if the user presses a cancel button U405, the process can be cancelled.

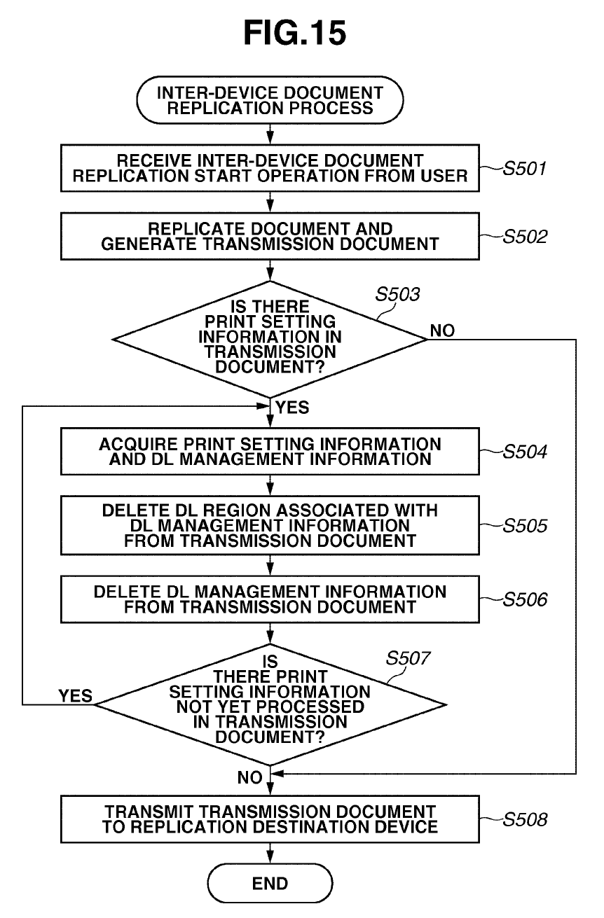

A process according to the third exemplary embodiment will be described below with reference to a flowchart illustrated in FIG. 15.

In step S501, the CPU 205 receives an operation to start the inter-device document replication process by the user pressing the execution button U404 on the operation unit 210.

In step S502, the CPU 205 replicates the document and generates a transmission document.

In step S503, the CPU 205 determines whether there is print setting information x5 in the metadata b of the transmission document. If the CPU 205 determines that there is the print setting information x5 in the metadata b of the copy document (YES in step S503), the process proceeds to step S504. In step S504, the CPU 205 acquires the print setting information x5 and the DL management information x6.

In step S505, the CPU 205 deletes the DL region c associated with the DL management information x6 from the transmission document.

In step S506, the CPU 205 deletes the DL management information x6 from the transmission document.

In step S507, the CPU 205 determines whether there is print setting information x5 that is not yet processed in the transmission document.

If the CPU 205 determines that there is print setting information x5 that is not yet processed in the transmission document (YES in step S507), the process returns to step S504.

On the other hand, if there is no print setting information x5 that is not yet processed in the transmission document (NO in step S507), the process proceeds to step S508. In step S508, the CPU 205 transmits the transmission document to the replication destination device. The process then ends.

If, in step S503, the CPU 205 determines that there is no print setting information x5 in the metadata b of the transmission document (NO in step S503), the process proceeds to step S508. In step S508, the CPU 205 transmits the transmission document to the replication destination device. The process then ends.

In step S508, the device receiving the transmission document stores the transmission document in the designated storage destination.

As a result of the above-described process, the document from which the DL region c and the DL management information x6 are deleted is transmitted to the replication destination device.

By comparing the data amount of the document to be transmitted with a data transmission rate of a line used in transmission, the CPU 205 can delete only a portion of the DL region c and the DL management information x6 instead of deleting all of the DL region c and the DL management information x6.

Further, the number of reprinting of a document performed by a color MFP that transmits the document can be counted, so that the DL which corresponds to the print setting whose number of counts is large is not deleted.

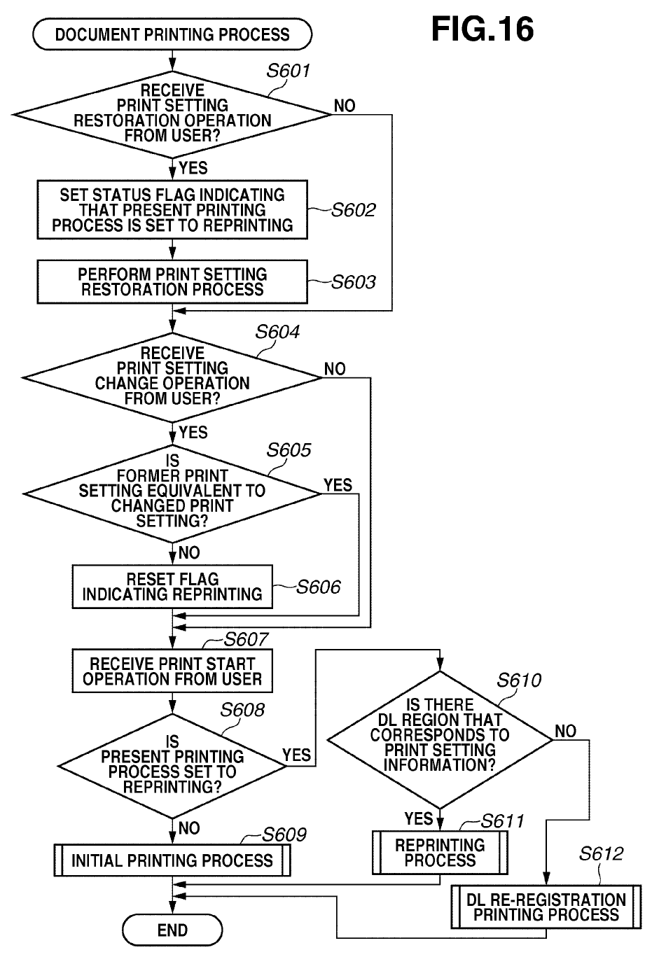

A document printing process performed by the device receiving the document replicated in the inter-device document replication process will be described below with reference to FIG. 16.

In step S601, the CPU 205 determines whether a print setting restoration operation is received from the user operating on the operation unit 210. If the CPU 205 determines that the print setting restoration operation is not received (NO in step S601), the process proceeds to step S604.

On the other hand, if the CPU 205 determines that the print setting restoration operation is received (YES in step S601), the process proceeds to step S602. In step S602, the CPU 205 sets a status flag indicating reprinting.

In step S603, the CPU 205 performs a print setting restoration process by restoring the print setting information x5 and reflecting the restored print setting information x5 in the present print setting.

In step S604, the CPU 205 determines whether a print setting change operation is received from the user operating the operation unit 210. If the CPU 205 determines that the print setting change operation is not received (NO in step S604), the process proceeds to step S607.

On the other hand, if the CPU 205 determines that the print setting change operation is received (YES in step S604), the process proceeds to step S605.

In step S605, the CPU 205 determines whether the former print setting is equivalent to the changed print setting. The equivalency of the former print setting to the changed print setting has the same significance as in the first and second exemplary embodiments. If the CPU 205 determines that the former print setting is equivalent to the changed print setting (YES in step S605), the process proceeds to step S607.

If the CPU 205 determines that the former print setting is not equivalent to the changed print setting (NO in step S605), the process proceeds to step S606.

In step S606, the CPU 205 resets the status flag indicating reprinting.

In step S607, the CPU 205 receives a print start operation from the user pressing the print start button U109.

In step S608, the CPU 205 determines whether the present printing process is set to reprinting by referring to the status flag indicating reprinting.

If the CPU 205 determines that the present printing process is not set to reprinting (NO in step S608), the process proceeds to step S609. In step S609, the CPU 205 performs the initial printing process described in the first exemplary embodiment with reference to FIG. 9. The process then ends.

On the other hand, if the CPU 205 determines that the present printing process is set to reprinting (YES in step S608), the process proceeds to step S610.

In step S610, the CPU 205 determines whether there is a DL region c that corresponds to the print setting information x5.

If the CPU 205 determines that there is a DL region c that corresponds to the print setting information x5 (YES in step S610), the process proceeds to step S611. In step S611, the CPU 205 executes the reprinting process described in the first exemplary embodiment with reference to FIG. 10. The process then ends.

If the CPU 205 determines that there is no DL region c that corresponds to the print setting information x5 (NO in step S610), the process proceeds to step S612. In step S612, the CPU 205 executes a DL re-registration printing process to be described below. The process then ends.

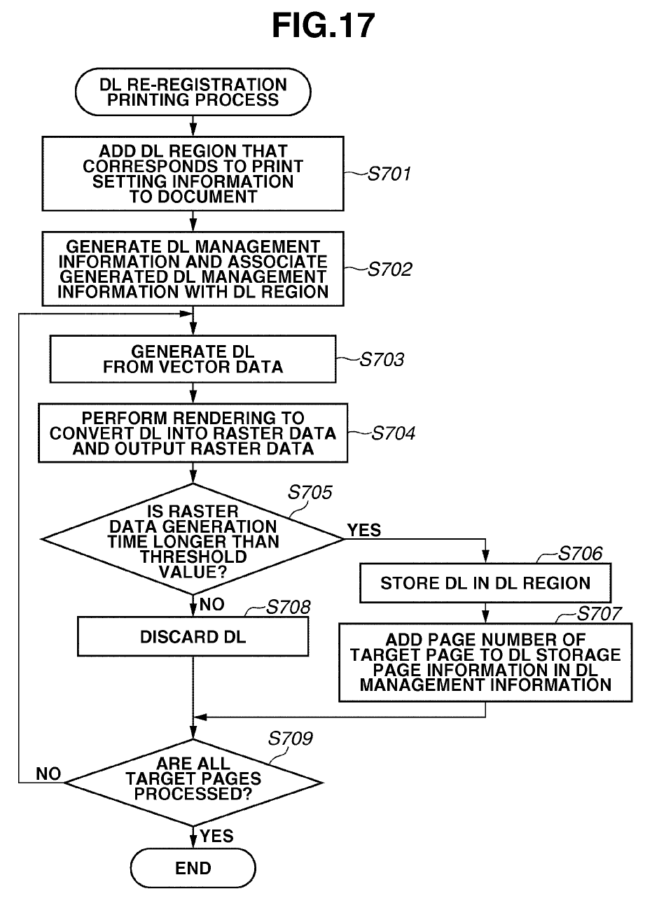

The DL re-registration printing process in step S612 illustrated in FIG. 16 will be described below with reference to FIG. 17.

In step S701, the CPU 205 adds to the document the DL region c that corresponds to the generated print setting information x5.

In step S702, the CPU 205 generates DL management information x6 that corresponds to the print setting information x5 and associates the created DL management information x6 with the DL region c generated in step S701. As a result of the above-described operations, the DL management information x6 and the DL region c that correspond to the print setting information x5 are generated in the document.

In step S703, the CPU 205 sequentially performs a printing process on the print target pages. Further, the CPU 205 causes the PDL analysis unit 1104 to convert the vector data a of the target page to a DL to generate the DL.

In step S704, the CPU 205 causes the data rendering unit 1105 to convert the DL into raster data for drawing an image and to output the raster data to the device I/F 217.

In step S705, the CPU 205 determines whether a raster data generation time is longer than a threshold value in the device I/F 217.

If the CPU 205 determines that the raster data generation time is longer than the threshold value (YES in step S705), the process proceeds to step S706. In step S706, the CPU 205 stores the DL generated in step S703 in the DL region c of the document.

In step S707, the CPU 205 further adds a page number of the target page to the DL storage page information of the DL management information x6. The process then proceeds to step S709.

If, in step S705, the CPU 205 determines that the raster data generation time is not longer than the threshold value (NO in step S705), the process proceeds to step S708. In step S708, the CPU 205 deletes the DL generated in S703.

In step S709, the CPU 205 determines whether all target pages have been processed.

If the CPU 205 determines that there is a target page that has not yet been processed (NO in step S709), the process returns to step S703. On the other hand, if the CPU 205 determines that all target pages have been processed (YES in step S709), the process ends.

By performing the above-described process, the DL of the page in which raster data generation time is longer than the threshold value is stored in the document when the document is printed. Further, the page number is described in the DL management information x6 when the document is printed.

As described above, an image processing apparatus according to the third exemplary embodiment can realize a reprinting function in which there is no image degradation due to editing and can store and manage print data that corresponds to a plurality of print settings. As a result, printing can be performed at high speed even in a case where printing is performed by switching between a plurality of print settings.

Further, according to the third exemplary embodiment, a print setting that the user previously instructed can be restored.

Further, according to the third exemplary embodiment, the data transfer amount can be reduced by printing the document in the replication destination device. Further, the print setting that is previously instructed to the transfer source device can also be stored in the transfer destination device. As a result, the user can process a document with the same operability even in a case where the document is replicated between devices, so that a user operation can be assisted.

The present invention can be embodied as a system, apparatus, method, program or a storage medium. More specifically, the present invention can be applied to a system including a plurality of devices or to an apparatus of a single device.

According to the above-described exemplary embodiments, an image processing apparatus stores resolution-independent data, print setting information, and resolution-dependent drawing data while associating them with one another as print data. As a result, the image processing apparatus can realize a reprinting function which performs printing without image degradation caused by a process according to a print setting. Further, the image processing apparatus can store and manage print data that corresponds to a plurality of print settings by adding new resolution-dependent drawing data. Therefore, the image processing apparatus can print at high speed even in a case where printing is performed by switching between a plurality of print settings.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-032269 filed Feb. 13, 2008, which is hereby incorporated by reference herein in its entirety.

What is claimed is:

1. An image processing apparatus comprising:
a storing unit configured to store, as a document, resolution-independent data, print setting data, and resolution-dependent drawing data obtained by converting the resolution-independent data according to the print setting data, while associating the resolution-independent data, the print setting data, and the resolution-dependent drawing data with one another; and
a control unit configured to perform a printing process using one of the resolution-independent data and the resolution-dependent drawing data according to a print setting set during printing and the print setting data.

2. The image processing apparatus according to claim 1, further comprising:
a first determination unit configured to determine whether the print setting set during printing is equivalent to the print setting data; and
a second determination unit configured to determine whether the resolution-dependent drawing data of a document instructed to be printed is stored in the storing unit,
wherein the control unit is configured to perform a printing process using the resolution-dependent drawing data if the first determination unit determines that the print setting set during printing is equivalent to the print setting data and the second determination unit determines that the resolution-dependent drawing data of a document instructed to be printed is stored in the storing unit.

3. The image processing apparatus according to claim 1, wherein the storing unit is configured to store the resolution-dependent drawing data after converting the resolution-independent data into the resolution-dependent drawing data if a raster generation time for converting the resolution-independent data into the resolution-dependent drawing data is longer than a threshold value.

4. The image processing apparatus according to claim 3, wherein the resolution-independent data includes a plurality of pages, and
wherein the storing unit is configured to determine whether the raster generation time for converting the resolution-independent data into the resolution-dependent drawing data is longer than the threshold value with respect to each of the plurality of pages.

5. The image processing apparatus according to claim 1, wherein the print setting data includes number of prints, side to be printed, paper size, and finishing.

6. The image processing apparatus according to claim 1, further comprising a display unit configured to display a list of the print setting data,
wherein the control unit is configured to perform the printing process according to print setting information selected from the displayed list.

7. The image processing apparatus according to claim 1, wherein the control unit is configured to delete the resolution-dependent drawing data from a document including the resolution-independent data, the print setting data, and the resolution-dependent drawing data stored in the storing unit, if an inter-device replication of the document is instructed.

8. A method comprising:
storing, as a document in a storing unit, resolution-independent data, print setting data, and resolution-dependent drawing data obtained by converting the resolution-independent data according to the print setting data, while associating the resolution-independent data, the print setting data, and the resolution-dependent drawing data with one another; and
performing a printing process using one of the resolution-independent data and the resolution-dependent drawing data according to a print setting set during printing and the print setting data.

9. The method according to claim 8, further comprising:
determining whether the print setting set during printing is equivalent to the print setting data;
determining whether the resolution-dependent drawing data of a document instructed to be printed is stored in the storing unit; and
performing a printing process using the resolution-dependent drawing data if it is determined that the print setting set during printing is equivalent to the print setting data and it is determined that the resolution-dependent drawing data of a document instructed to be printed is stored in the storing unit.

10. The method according to claim 8, further comprising storing, in the storing unit, the resolution-dependent drawing data after converting the resolution-independent data into the resolution-dependent drawing data if a raster generation time for converting the resolution-independent data into the resolution-dependent drawing data is longer than a threshold value.

11. The method according to claim 10, wherein the resolution-independent data includes a plurality of pages, and
wherein the method further comprises determining whether the raster generation time for converting the resolution-independent data into the resolution-dependent drawing data is longer than the threshold value with respect to each of the plurality of pages.

12. The method according to claim 8, wherein the print setting data includes number of prints, side to be printed, paper size, and finishing.

13. The method according to claim 8, further comprising:
displaying a list of the print setting data, and
performing the printing process according to print setting information selected from the displayed list.

14. The method according to claim 8, further comprising deleting the resolution-dependent drawing data from a document including the resolution-independent data, the print setting data, and the resolution-dependent drawing data stored in the storing unit, if an inter-device replication of the document is instructed.

15. A computer-readable storage medium storing instructions which, when executed by an apparatus, cause the apparatus to perform operations comprising:
storing, as a document in a storing unit, resolution-independent data, print setting data, and resolution-dependent drawing data obtained by converting the resolution-independent data according to the print setting data, while associating the resolution-independent data, the print setting data, and the resolution-dependent drawing data with one another; and
performing a printing process using one of the resolution-independent data and the resolution-dependent drawing data according to a print setting set during printing and the print setting data.
